(19) United States
(12) Patent Application Publication
(10) Pub. No.: US 2020/0034369 A1
(43) Pub. Date: Jan. 30, 2020

(54) ACTIVE LISTENING TO MANAGE ADAPTIVE CONTENT ITEMS

(71) Applicant: Primer Technologies, Inc., San Francisco, CA (US)

(72) Inventors: Sean Gourley, San Francisco, CA (US); John Bohannon, San Francisco, CA (US)

(21) Appl. No.: 16/523,233

(22) Filed: Jul. 26, 2019

Related U.S. Application Data
(60) Provisional application No. 62/712,104, filed on Jul. 30, 2018.

(51) Int. Cl. G06F 16/2457; G06F 16/332; G06F 16/383; G06F 16/34; G06F 16/335

(52) U.S. Cl. CPC G06F 16/24578; G06F 16/3329; G06F 16/337; G06F 16/383; G06F 16/345; G06F 16/3326

(57) ABSTRACT

Systems, methods, and software described herein provide improvements for dynamically modifying the presentation of content items to end users. In one example, a summary service determines first content items associated with an end user and determines a first sequence for the first content items. The summary service further monitors user interactions with one or more secondary services and determines content of interest for the end user based on the user interactions. As the content of interest is identified, the summary service determines second content items to be presented to the end user and determines a second sequence for the second content items based on the content of interest.

### RELATED APPLICATIONS

This application hereby claims the benefit of and priority to U.S. Provisional Patent Application No. 62/712,104, titled “ACTIVE LISTENING TO MANAGE ADAPTIVE CONTENT ITEMS,” filed Jul. 30, 2018, and which is hereby incorporated by reference in its entirety.

### BACKGROUND

News sources often generate images, articles, graphs, and other similar objects that are used in providing information about a particular event. These events may include financial events, world news events, local news events, among other possible events. The objects generated may include various facts, relevant images, or other similar data that can be used in providing a reader or viewer with information about the particular event. However, although news stories may provide information about a particular event, different news stories may provide different information, and may even provide false information. As a result, readers and viewers of the objects may find it difficult to identify important information within the objects, as well determine the information that is factually correct.

### Overview

Provided herein are enhancements for managing content items using active listening across computing devices. In one implementation, a method of managing content items for end users includes determining first content items to be presented to an end user and determining a first sequence for the first content items. The method further includes monitoring user interactions with one or more secondary services and determining content of interest for the end user based on the user interactions. The method also provides determining second content items to be presented to the end user and determining a second sequence for the second content items.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment to manage adaptive content items according to an implementation.

FIG. 2 illustrates an operation of a summary service according to an implementation.

FIG. 3 illustrates a timing diagram of managing adaptive content items according to an implementation.

FIG. 4 illustrates an operation of a summary service to update content based on end user communications according to an implementation.

FIGS. 5A-5B illustrate an organization of content items according to an implementation.

FIGS. 6A-6B illustrate an organization of content items according to an implementation.

FIG. 7 illustrates a summary service computing system according to an implementation.

### DETAILED DESCRIPTION

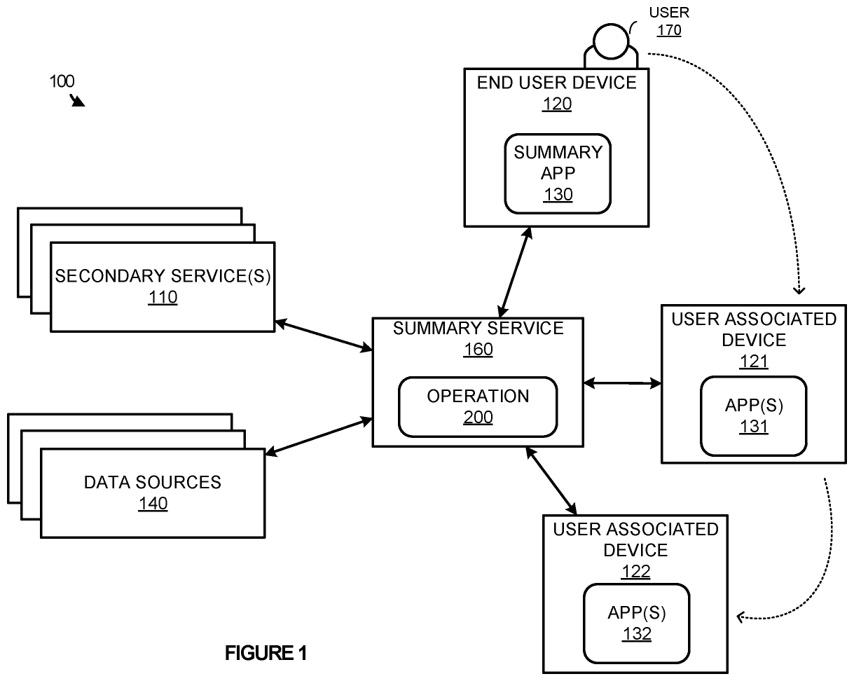

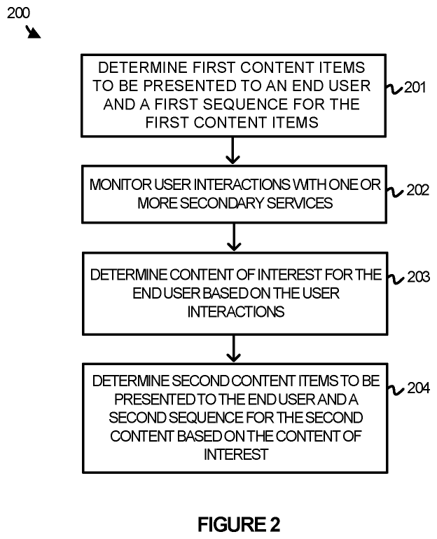

FIG. 1 illustrates a computing environment 100 to manage adaptive content items according to an implementation. Computing environment 100 includes summary service 160, secondary service(s) 110, data sources 140, end user device 120, user associated devices 121-122, and user 170. End user device 120 further includes summary application 130, and user associated devices 121-122 include applications 131-132, wherein applications 131-132 may be associated with secondary service(s) 110 in some implementations. Summary service 160 is configured to provide operation 200, which is further described in FIG. 2.

In operation, summary service 160 obtains data objects from data sources 140 and provides summaries of the data objects to various end users, such as end user 170. In some implementations, summary service 160 may obtain news articles, social media posts, images, blog posts, or some other similar data object from data sources 140 and extract relevant information from the data objects to generate summaries of events for an associated end user. These events may comprise product release dates, terrorist attacks, financial events (such as an initial public offering), a person of interest, a location of interest, an event for an organization (such as a product recall), or some other similar event. In extracting the relevant information, summary service 160 may determine frequently used data points across multiple data objects, data points that are emphasized and/or placed at particular portions in the data object, data points that introduce values of interest to the particular event topic, data points that are relevant to a particular user based on a profile for the user, or some other similar extraction operation for the data. Once extracted, the data may be aggregated into a content item (or summary) that can be provided to the required end user.

In some examples, to identify the events for the content items, summary service 160 may be used to identify events based on the information in the data objects. For example, if multiple articles referenced the release of a new product, summary service 160 may identify the release of the product as an event and may extract information from the data objects to generate a content item that summarizes the release of the new product. This information may include the date of the product, the business sector for the new product, any reviews of the new product, any persons of interest linked to the new product, or some other similar information. In other implementations, rather than automating the process of identifying the events, an administrator or user may also define information for an event of interest. Using the previous example, rather than summary service 160 identifying the product release, an administrator may define the even and summary service 160 may generate a content item that summarizes the release based on data objects obtained from data sources 140.

Here, in addition to generating summaries about events, summary service 160 is also used to dynamically manage the types of content items that are identified for individual end users and the sequence for which the content items are presented to the individual. Referring to the example in computing environment 100, summary service 160 may dynamically modify the types of content items and the sequencing of the content items that are presented to end user 170 using summary application 130 on end user device 120. In modifying the types and sequencing of the data items, summary service 160 may monitor interactions of end user 170 with other applications on end user device 120, as well as interactions with applications 131-132 on user associated devices 121-122. These interactions may comprise text or voice interactions (e.g. voice commands or text-based searches) and may be obtained directly from the user associated devices or may be obtained from secondary service(s) 110. As an example, summary service 160 may monitor social media posts from end user 170 via an application programming interface (API) with the social media service in secondary service(s) 110. From the posts, summary service 160 may dynamically modify the content items that are presented to end user 170.

FIG. 2 illustrates an operation 200 of a summary service according to an implementation. The processes in operation 200 are referenced parenthetically in the paragraphs that follow with references to systems and elements of computing environment 100 of FIG. 1.

As depicted, operation 200 includes determining (201) first content items to be presented to an end user and determining a first sequence for the content items. In some implementations, summary service 160 obtains data objects from data sources 140 and generates summary content items of events identified within the data objects. These summaries may include text-based summaries with various data points of interest included, graphs with various data points of interest, images, or some other similar summary, including combinations thereof. As the content items are identified, summary service 160 may determine a sequence for how the content items should be presented to the user. This sequence may be based on preferences provided by the end user, preferences identified from previously presented content items to the end user, the importance of the event, or some other similar sequencing factor. As an example, a user may indicate that they prefer financial event summaries ahead of sports related summaries. As a result, summary service may sequence the summaries, such that the financial events are prioritized ahead of the sports related events. This sequencing in some examples may include prioritizing or emphasizing the financial events in a list, in font size, in color, or in some other similar prioritization method when providing the content items to the end user.

Once the first content items and the sequencing for the first content items is determined, operation 200 further monitors (202) user interactions with one or more secondary services, wherein the interactions may comprise text-based interactions, voice-based interactions, or any other similar interaction. These interactions may be directly monitored from devices 120-122 or may be identified from secondary service(s) 110. As the user interactions are identified, operation 200 further determines (203) content of interest for the end user based on the user interactions. As an example, user associated device 121 may comprise a “smart” speaker, wherein the user may provide queries to the speaker and receive responses to the queries, the speaker may monitor habits of the user to determine actions to take (e.g. ordering new products), or may provide various other functions for the end user. As the user interacts with user associated device 121, summary service 160 may obtain information about the interactions, and determine whether the interactions correspond to content of interest. For example, summary service 160 may obtain transcripts of various voice communications with user associated device 121, and from the transcripts identify content of interest for the end user. This content of interest may correspond to particular data points of interest, such as values associated with an event, may correspond to particular topics or events of interest, such as financial events, sporting events, and the like, or may comprise any other similar content of interest. In at least one implementation, summary service 160 may identify content of interest for the user based on the frequency that the user interactions include information about particular content. For example, summary service 160 may identify content of interest based on the frequency that the user interactions comprise interactions regarding financial events over sporting events, wherein the increased user interactions may demonstrate a preference that the financial content is more relevant to the end user than sports content. Similarly, summary service 160 may identify content of interest within a particular event topic, wherein user interactions may indicate that the user prefers opinions over facts or values for a particular event topic. As an example, end user 170 may frequently provide user interactions that correspond to opinions about a new product release over the values associated with the new product release (e.g. processor speed, storage, and the like). Consequently, for future events, the summary content item that is generated for a product release event may promote the opinions of reviewers over the specification values associated with the product.

As the content of interest is identified for end user 170, operation 200 further determines (204) second content items to be presented to the end user and a second sequence for the second content items based on the content of interest. As described previously, content of interest may be identified based on the frequency that the user interactions include particular data points, based on the types of queries or user interactions related to particular events, or based on some other similar interest factor for an end user. For example, when an end user generates multiple queries to an application on user associated device 121 (e.g. finance queries), summary service 160 may determine that the end user is most interested in finance content items. Consequently, when summary service 160 determines the second content items, such as event summaries, summary service may identify and promote finance related content items over other types of items. Similarly, based on the user interactions identified by summary service 160, summary service may modify the content in each of the content items to more align with the user interests, wherein values, opinions, and other data points in the content items may be prioritized based on the user interests.

In some implementations, the second content items that are identified for end user 170 may include at least a portion of the first content items. In other implementations, the second content items may comprise entirely different content items related to the same or different events. As an example, based on the interactions of end user 170 using devices 120-122, summary service may promote particular event types (e.g. events related finance) over other event types. As a result, new summary content items may be generated that better suit the end user interests to particular event types.

In some implementations, the determination of the content items and the determination for the sequencing of the data items may occur in response to an end user request for the content items. In other implementations, summary service 160 may determine the first content items and sequencing for the data items periodically, when new events are identified, or at any other interval.

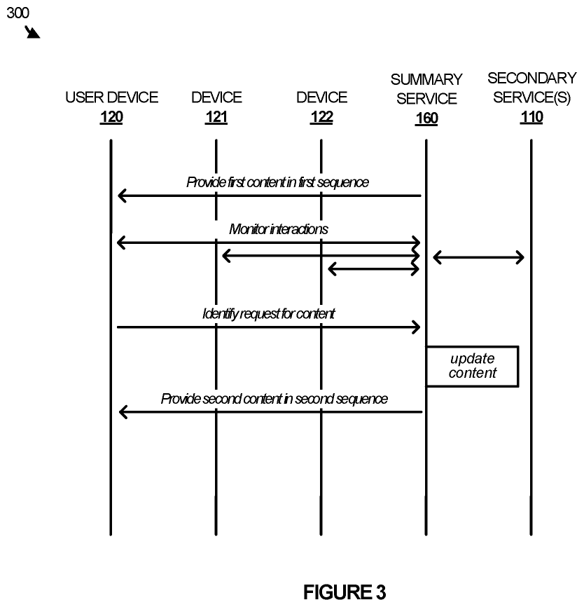

FIG. 3 illustrates a timing diagram 300 of managing adaptive content items according to an implementation. Timing diagram 300 includes systems and elements of computing environment 100 of FIG. 1. Timing diagram 300 omits data sources 140 for the sake of clarity, however, it should be understood that summary service 160 may obtain data objects from data sources to generate content items for an end user.

In operation, summary service 160 determines and provides first content in a first sequence to user device 120, wherein user device 120 may execute an application capable of displaying, generating audio, or providing some other user interface means for the first content. The content items may be provided as a list, may be provided one after another, or may be provided in any other manner where at least a portion of the first content items are promoted over other content items. Here, once the first content items are provided to end user device 120, summary service 160 further monitors interactions of the end user (end user 170 of FIG. 1) with devices 120-122 and secondary service(s) to identify content of interest associated with the end user. These interactions may comprise queries to applications other than summary application associated with summary service 160, may comprise communications with other end users using various applications, or may comprise any other similar text or voice-based interaction. For example, device 121 may comprise an internet connected device capable of interacting with one or more services to send messages, order or purchase object, provide voice communications, or some other similar operation. While the end user interacts with device 121, records of the interactions may be made available to summary service 160, wherein summary service 160 may obtain information about the interactions from the device itself or via secondary service(s) 110. Thus, if the end user belonged to a social media service, summary service 160 may obtain information about the text or voice interactions from the service.

As the interactions are monitored for the end user, the end user may generate another request for content at end user device 120, which is identified by summary service 160. In response to the request, summary service 160 may update content that is provided to the end user based on the monitored interactions and provide second content in a second sequence to the requesting user at end user device 120. These updated content items may include new content items with different event types, may include the same event types with different content items therein, a reorganization of the event types or the content therein, or some other similar updated content.

While demonstrated in the example of FIG. 3 as requiring a user request to update the content items and the sequence of the content items, it should be understood that the content items and sequence may be updated at any interval. These intervals may be periodic, based on the quantity of interactions the user has with various associated devices, or at any other similar interval.

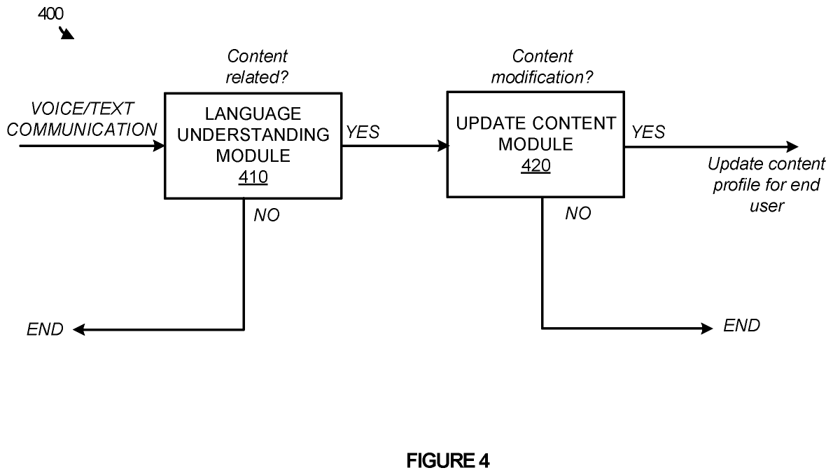

FIG. 4 illustrates an operation 400 of a summary service to update content based on end user communications according to an implementation. Operation 400 includes processes 410 and 420, and may be implemented by a summary service, such as summary service 160.

As described herein, a summary service may obtain information about voice and communication interactions with one or more applications and/or devices outside of an application for the summary service. In some implementations, the interaction information may be obtained from user devices associated with a particular end user, such as a smartphone, a smart speaker, a computer, a tablet, or some other similar device, wherein the device may execute one or more applications capable of capturing user interactions. These interactions may be directly with the device or may monitor conversations or other communications indirectly, such as conversations in a room. In other implementations rather than being provided with the communication directly from the device, the summary service may obtain the communications from services, wherein the services may comprise social media services, shopping services, or some other similar type of services. In some examples, the services may provide all communications, however, it should be understood that only a portion of the communications may be provided in some implementations.

As a communication is identified by the summary service, the summary service may use a language understanding module 410 to determine whether the communication is related to content that is provided to the end user as part of the summary service. In some implementations, a transcript of the communication may be inspected to identify words and phrases of interest related to the content that is provided to the requesting user. For example, if an end user received summaries regarding sports, finance, politics, any terms related to those subjects may classify the communication as content related. In contrast, if the communication were not related to those subjects, the operation of the summary service may end.

If the communication is content related, language understanding module 410 may forward the communication to update content module 420 that is used to update preferences for the content that is supplied to the associated user. In particular, update content module 420 may determine whether the communication causes a modification to the profile for the end user. This update may be triggered based on values, words, phrases, or some other similar information identified in the transcript of the communication. As an example, when an end user cites particular facts about a previously identified event, the fact type (e.g. date, person of interest, monetary values, and the like) may be promoted for future content items that are presented to the end user. Similarly, if a general topic is discussed in the communication by the end user over other topics, such as finance over sports, then update content module 420 may update the content preferences of the user to promote finance over sports. In some implementations, the content of the communication may cause a change in the preferences of the end user, however, it should be understood that the preferences may not change depending on the information in the communication. Thus, when the first content items are generated using a first form of the user profile (e.g. data points of interest in the content items, content item topics or types of interest, or some other similar preference), the profile may not change when the user connections do not indicate differences in content of interest for the user.

In at least one implementation, in determining whether the content preferences for the end user should be modified, the summary service may monitor the frequency that various terms and topics are used by the end user. In particular, rather than monitoring a single communication, the summary service may monitor communications and interactions of the user over time to determine trends in the communication habits of the end user. Based on the information across multiple communications, the summary service may update the preferences of the end user. For example, the end user may frequently have interactions regarding financing during morning hours but may frequently have interactions regarding sports during night hours. As a result, the content service may dynamically adjust the content items that are provided to the end user based on the time of day, where finance content items may be promoted over sports items during morning time periods, while sports may be promoted over finance content items during later periods in the day.

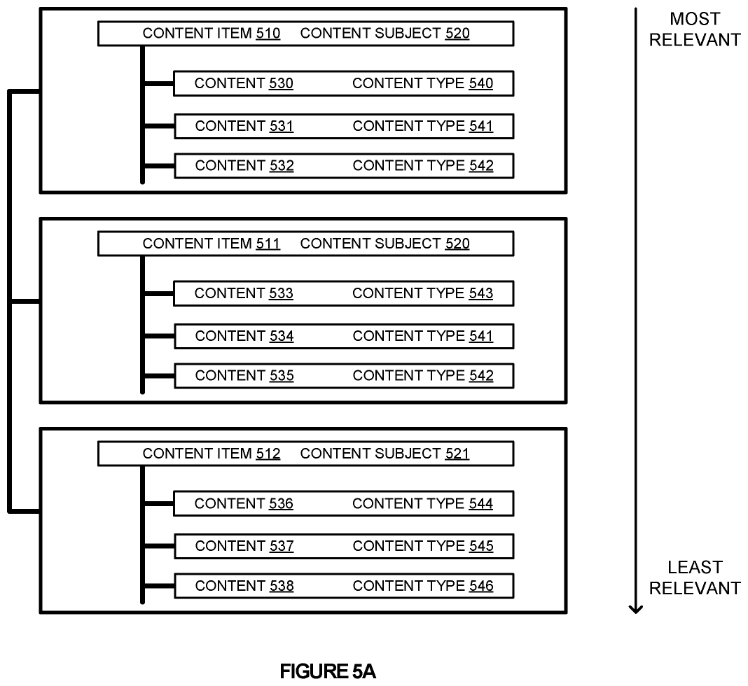

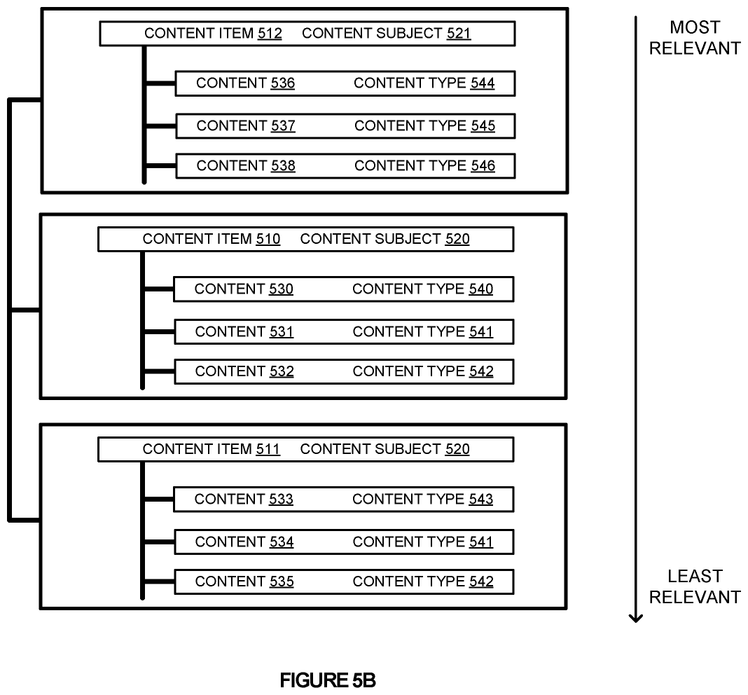

FIGS. 5A-5B illustrate an organization of content items according to an implementation. FIGS. 5A-5B include content items 510-512 with content subjects 520-521. Content items 510-512 comprise content 530-538, wherein content 530-538 is of content types 540-546. Content types 540-546 may each correspond to dates, persons of interest, values of interest, opinions, or some other similar content type. Content subjects 520-521 may each correspond to product releases, legislation, economic events, sporting events, or some other similar event topic.

Referring first to FIG. 5A, content items 510-512 are representative of identified content items to be provided to an end user of a summary service. Content items 510-512 may correspond to text-based summaries (e.g. one or more paragraphs), may correspond to graphs, may correspond to images, or some other similar summary, including combinations thereof. As described herein, a summary service may obtain data objects from a plurality of data sources and generate summary content items based on the data sources. Here, as the summary content items 510-512 are generated, the content items are allocated a first sequence to be provided to an end user when required. This first sequence may be based on defined preferences from the end user, interactions with the user while providing previous content items, or based on speech or text-based interactions as further described in the operations that follow.

After a first sequence for content items 510-512 is identified (demonstrated as most relevant to least relevant) for the end user, the summary service may monitor user interactions with various applications across one or more computing devices. These devices may include smart speakers, smartphones, computers, tablets, or some other similar computing device. The user interactions may comprise direct interactions with the applications (e.g. requesting an application for a weather report), or may comprise indirect interactions, wherein the application may monitor or provide a communication portal for the end user with other users (e.g. smart speaker monitoring a conversation of the end user with another person). As the user interactions are identified, at least a portion of the user interactions may be provided to the summary service. Once provided, the summary service may process the interactions as described herein. In some implementations, the summary service may identify portions of the interactions that are related to content of interest and modify preferences of the end user based on the content of interest. This content of interest may be identified based on the frequency or trends that the end user interactions correspond to a particular content type (e.g. values, opinions, and the like), may be based on the frequency or trends that correspond to particular subject types, or may be based on any other similar factor to determine content of interest for an end user.

Referring now to FIG. 5B, once the content of interest is identified for the particular end user, the summary service may generate second content items and sequences for the content items based on the content of interest. Here, the summary service determines the same content items as were provided in FIG. 5A should be identified for the end user, however, the summary service changes the sequence of the content items. In particular, content item 512 is promoted to the most relevant position over content items 510-511. This promotion may occur based on the end user interaction including information related to the particular content item, information related to content subject 521, or some other similar information that promotes content item 512 over content items 510-511.

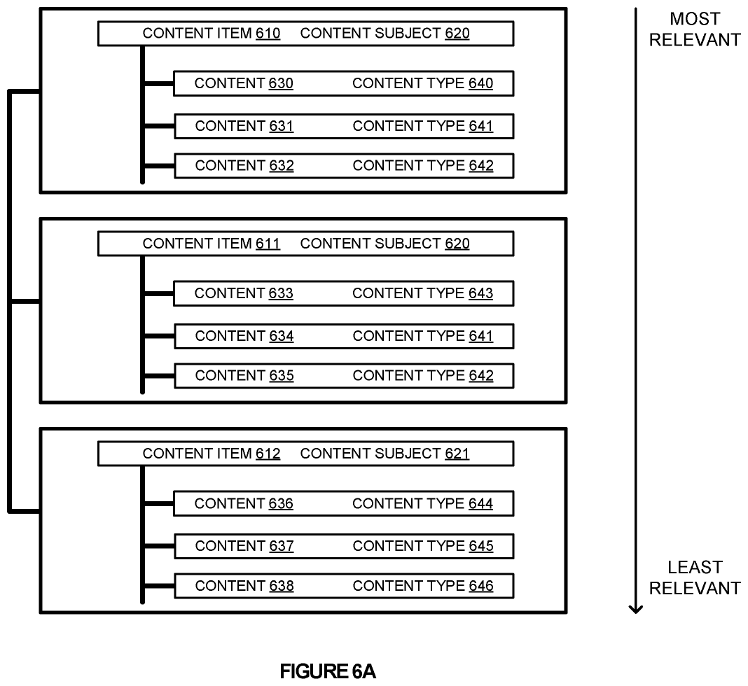

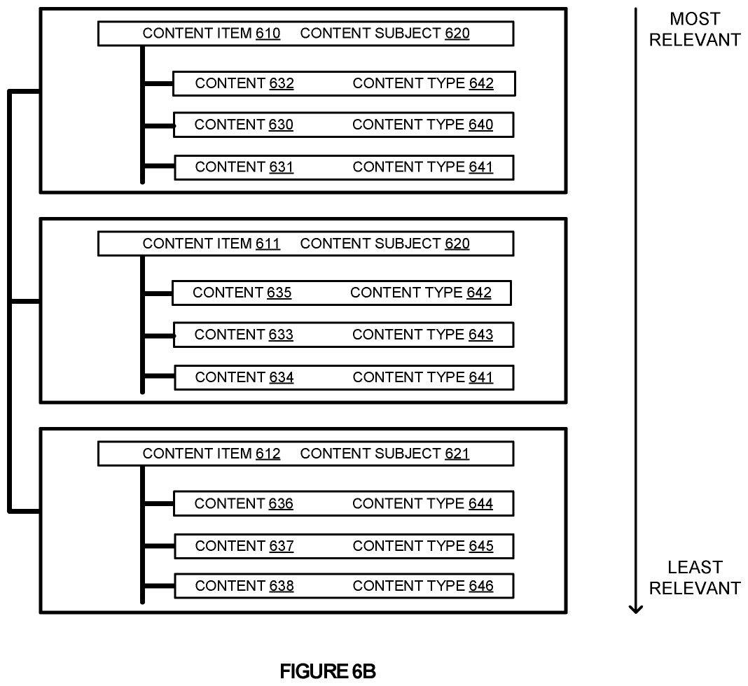

FIGS. 6A-6B illustrate an organization of content items according to an implementation. FIGS. 6A-6B include content items 610-612 with content subjects 620-621. Content items 610-612 comprise content 630-638 wherein content 630-638 is of content types 640-646. Content types 640-646 may each correspond to dates, persons of interest, values of interest, opinions, or some other similar content type. Content subjects 620-621 may each correspond to product releases, legislation, economic events, sporting events, or some other similar event topic.

Referring first to FIG. 6A, content items 610-612 are representative of identified content items to be provided to an end user of a summary service. Content items 610-612 may correspond to text-based summaries (e.g. one or more paragraphs), may correspond to graphs, may correspond to images, or some other similar summary, including combinations thereof. As described herein, a summary service may obtain data objects from a plurality of data sources and generate summary content items based on the data sources. Here, as the summary content items 610-612 are generated, the content items are allocated a first sequence to be provided to an end user when required. This first sequence may be based on defined preferences from the end user, interactions with the user while providing previous content items, or based on speech or text-based interactions as further described in the operations that follow.

After a first sequence for content items 610-612 is identified (demonstrated as most relevant to least relevant) for the end user, the summary service may monitor user interactions with various applications across one or more computing devices. These devices may include smart speakers, smartphones, computers, tablets, or some other similar computing device. The user interactions may comprise direct interactions with the applications (e.g. requesting an application for a weather report), or may comprise indirect interactions, wherein the application may monitor or provide a communication portal for the end user with other users (e.g. smart speaker monitoring a conversation of the end user with another person). As the user interactions are identified, at least a portion of the user interactions may be provided to the summary service. Once provided, the summary service may process the interactions as described herein. In some implementations, the summary service may identify portions of the interactions that are related to content of interest and modify preferences of the end user based on the content of interest. This content of interest may be identified based on the frequency or trends that the end user interactions correspond to a particular content type (e.g. values, opinions, and the like), may be based on the frequency or trends that correspond to particular subject types, or may be based on any other similar factor to determine content of interest for an end user.

Referring to FIG. 6B, once the content of interest information is identified for the end user, the summary service may identify new content items for the end user and sequence the content items to promote particular items over others. Here, the content items and content subjects remain the same from the initial determination to the second determination. However, the summary service reorganized information within the content items to correspond to content of interest. In particular, in content items 610-611, content type 642 is promoted over the other content types to provide the most relevant information to the end user. For example, instant messaging and voice communications may be used to identify that the end user prefers numerical values over other types of data types in a content item. Consequently, when the content items are identified, the content for those items may prioritized such that the numerical values are presented first to the end user.

Although demonstrated in the examples of FIGS. 5A-5B and 6A-6B as identifying initial content items and modifying the same content items to be provided to an end user, it should be understood that new content items may be identified during the subsequent content item determination process. These new items may be identified because the end user has viewed or interacted with the content item, because a content item is no longer relevant, because a content item is more relevant, or for any other similar reason. Further, in some implementations, when the content items are identified, a subset of all content items identified by the summary service may be allocated to the end user. This subset of content items may be identified based on the relevance to the end user and may be selected based on the content items that meet qualifying criteria (most relevant based on a scoring system, newest, and the like).

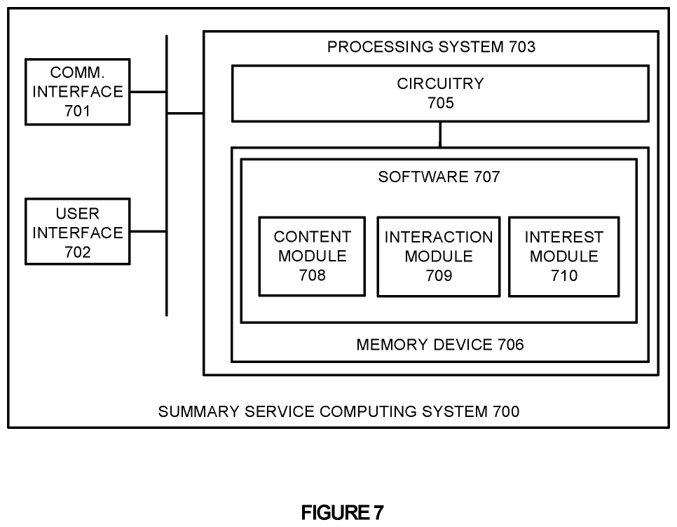

FIG. 7 illustrates a summary service computing system 700 according to an implementation. Computing system 700 is representative of any computing system or systems with which the various operational architectures, processes, scenarios, and sequences disclosed herein for an event summary service may be implemented. Computing system 700 is an example of summary service 160 of FIG. 1, although other examples may exist. Computing system 700 comprises communication interface 701, user interface 702, and processing system 703. Processing system 703 is linked to communication interface 701 and user interface 702. Processing system 703 includes processing circuitry 705 and memory device 706 that stores operating software 707. Computing system 700 may include other well-known components such as a battery and enclosure that are not shown for clarity.

Communication interface 701 comprises components that communicate over communication links, such as network cards, ports, radio frequency (RF), processing circuitry and software, or some other communication devices. Communication interface 701 may be configured to communicate over metallic, wireless, or optical links. Communication interface 701 may be configured to use Time Division Multiplex (TDM), Internet Protocol (IP), Ethernet, optical networking, wireless protocols, communication signaling, or some other communication format—including combinations thereof. In some implementations, communication interface 701 may be configured to communicate with data resources to obtain data objects that correspond to various events, and may further communicate with secondary services (servers, desktop computers, and the like) or user associated devices to obtain user interaction information. Communication interface 701 may further be configured to communicate with client or console devices of end users, wherein the users may request and receive content items (or summaries) from computing system 700. The users may request the content items via a dedicated application on the client device or may request the content items using web browsing application or some other similar application.

User interface 702 comprises components that interact with a user to receive user inputs and to present media and/or information. User interface 702 may include a speaker, microphone, buttons, lights, display screen, touch screen, touch pad, scroll wheel, communication port, or some other user input/output apparatus—including combinations thereof. User interface 702 may be omitted in some examples. In some implementations, user interface 702 may be used in obtaining user summary requests and providing the summary to the requesting user.

Processing circuitry 705 comprises microprocessor and other circuitry that retrieves and executes operating software 707 from memory device 706. Memory device 706 may include volatile and nonvolatile, removable and non-removable media implemented in any method or technology for storage of information, such as computer readable instructions, data structures, program modules, or other data. Memory device 706 may be implemented as a single storage device but may also be implemented across multiple storage devices or sub-systems. Memory device 706 may comprise additional elements, such as a controller to read operating software 707. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 705 is typically mounted on a circuit board that may also hold memory device 706 and portions of communication interface 701 and user interface 702. Operating software 707 comprises computer programs, firmware, or some other form of machine-readable program instructions. Operating software 707 includes content module 708, interaction module 709, and interest module 710, although any number of software modules may provide the same operation. Operating software 707 may further include an operating system, utilities, drivers, network interfaces, applications, or some other type of software. When executed by processing circuitry 705, operating software 707 directs processing system 703 to operate computing system 700 as described herein.

In one implementation, content module 708 directs processing system 703 to determine first content items and a sequence for the content items to be provided to an end user. This determination may be based on preferences provided from the end user, based on previously provided content items and feedback from the end user, based on user interactions with various other services, or based on any other similar information. Once the first content items and sequence are identified, interaction module 709 directs processing system to identify user interactions with one or more secondary services, wherein the secondary services may comprise social media applications, voice or text communication applications, personal assistant applications, or some other similar application. In some implementations, interaction module 709 may receive the information directly from devices associated with the end user, smartphone, smart speaker, computer, or some other similar end user device. In some examples, the information may be obtained from the services hosted on or more servers in data center for the application. These services may provide at least a portion of the user interactions to computing system 700 for processing, wherein the user interactions may comprise communications directly with the application, such as requests to a digital personal assistant application, or may comprise communications that are provided via the application, such as text or voice communications facilitated via the application.

Once the user interactions are identified, interest module 710 directs processing system 703 to determine content of interest based on the user interactions. After the content of interest is identified, content module 708 determines second content items for the end user and a sequence for the second content items to be provided to the end user based on the content of interest. In some implementations, the second content items may share at least a portion of the content items with the first content items. In some examples, the second content items may be provided with different content subjects being prioritized over other content subjects, with different content types in each of the content items being prioritized, or some other similar differentiation in content.

Returning to the elements of FIG. 1, data sources 140 may comprise websites and/or databases capable of providing news stories, social media posts, blog posts, images, and other similar types of objects to summary service 160. Data sources 140 may each comprise one or more communication interfaces and network interfaces, processing systems, computer systems, microprocessors, storage systems, storage media, or some other processing devices or software systems. Data sources 140 may each comprise one or more serving computing systems, desktop computing systems, or some other similar computing system.

Secondary service(s) 110 may comprise social media platforms, personal assistant platforms, communication platforms, or some other similar service capable of providing services via applications on end user devices. Data sources 140 may each comprise one or more communication interfaces and network interfaces, processing systems, computer systems, microprocessors, storage systems, storage media, or some other processing devices or software systems. Data sources 140 may each comprise one or more serving computing systems, desktop computing systems, or some other similar computing system.

Summary service 160 comprise communication interfaces and network interfaces, processing systems, computer systems, microprocessors, storage systems, storage media, or some other processing devices or software systems, and can be distributed among multiple devices. Summary service 160 may include software such as an operating system, logs, databases, utilities, drivers, networking software, and other software stored on a computer-readable medium.

End user device 120 and user associated devices 121-122 may each comprise smartphones, smart speakers, computers, tablets, or some other similar computing device. End user device 120 and user associated devices 121-122 may each comprise communication interfaces and network interfaces, processing systems, computer systems, microprocessors, storage systems, storage media, or some other processing devices or software systems.

Communication between the summary service 110, data sources 140, secondary service(s) 110, and devices 120-122 may use metal, glass, optical, air, space, or some other material as the transport media. Communication between summary service 110, data sources 140, secondary service(s) 110, and devices 120-122 may use various communication protocols, such as Time Division Multiplex (TDM), asynchronous transfer mode (ATM), Internet Protocol (IP), Ethernet, synchronous optical networking (SONET), hybrid fiber-coax (HFC), circuit-switched, communication signaling, wireless communications, or some other communication format, including combinations, improvements, or variations thereof. Communication between summary service 110, data sources 140, secondary service(s) 110, and devices 120-122 may be a direct link or can include intermediate networks, systems, or devices, and can include a logical network link transported over multiple physical links.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of managing content items for end users, the method comprising
determining first content items to be presented to an end user;
determining a first sequence for the first content items;
monitoring user interactions with one or more secondary services;
determining content of interest for the end user based on the user interactions;
determining second content items to be presented to the end user based on the content of interest; and
determining a second sequence for the second content items based on the content of interest.

2. The method of claim 1, wherein the user interactions comprise voice and text communications using the one or more secondary services.

3. The method of claim 1, wherein the first content items comprise first summaries of a first plurality of events, and wherein the second content items comprise second summaries of a second plurality of events.

4. The method of claim 3, wherein determining the first content items to be presented to the end user comprises:
obtaining data objects from a plurality of data sources;
generating the first summaries of the first plurality of events based at least on content of the data objects.

5. The method of claim 4, wherein generating the first summaries of the first plurality of events based at least on content of the data objects comprises:
identifying data points for each of the first plurality of events based on a profile;
generating the first summaries based on the data points.

6. The method of claim 1, wherein determining the first content items to be presented to an end user comprises determining the first content items to be presented to an end user based on a profile associate the end user.

7. The method of claim 1 further comprising:
generating a first display comprising the first content items in the first sequence; and
generating a second display comprising the second content items in the second sequence.

8. The method of claim 1 further comprising:
obtaining a first request for the first content items from the end user;
providing the first content items in the first sequence to the end user in response to the first request;
obtaining a second request for the second content items from the end user; and
providing the second content items in the second sequence to the end user in response to the second request.

9. The method of claim 1, wherein the first content items and the second content items each comprise text-based summaries, graphs, or images.

10. A computer apparatus comprising:
one or more non-transitory computer readable storage media;
a processing system operatively coupled to the one or more non-transitory computer readable storage media; and
program instructions stored on the one or more non-transitory computer readable storage media to manage content items for end users that, when read and executed by the processing system, direct the processing system to at least:
determine first content items to be presented to an end user;
determine a first sequence for the first content items;
monitor user interactions with one or more secondary services;
determine content of interest for the end user based on the user interactions;
determine second content items to be presented to the end user based on the content of interest; and
determine a second sequence for the second content items based on the content of interest.

11. The computer apparatus of claim 10, wherein the user interactions comprise voice and text communications using the one or more secondary services.

12. The computer apparatus of claim 10, wherein the first content items comprise first summaries of a first plurality of events, and wherein the second content items comprise second summaries of a second plurality of events.

13. The computer apparatus of claim 12, wherein generating the first summaries of the first plurality of events based on content of the data objects comprises:
obtaining data objects from a plurality of data sources;
generating the first summaries of the first plurality of events based at least on content of the data objects.

14. The computer apparatus of claim 13, wherein generating the first summaries of the first plurality of events based at least on content of the data objects comprises:
identifying data points for each of the first plurality of events based on a profile;
generating the first summaries based on the data points.

15. The computer apparatus of claim 10, wherein determining the first content items to be presented to an end user comprises determining the first content items to be presented to an end user based on a profile associate the end user.

16. The computer apparatus of claim 10, wherein the program instructions further direct the processing system to:
generate a first display comprising the first content items in the first sequence; and
generate a second display comprising the second content items in the second sequence.

17. The computer apparatus of claim 10, wherein the program instructions further direct the processing system to:
obtain a first request for the first content items from the end user;
provide the first content items in the first sequence to the end user in response to the first request;
obtain a second request for the second content items from the end user; and
providing the second content items in the second sequence to the end user in response to the second request.

18. The computer apparatus of claim 10, wherein the first content items and the second content items each comprise text-based summaries, graphs, or images.

19. An apparatus comprising:
one or more non-transitory computer readable storage media; and
program instructions stored on the one or more non-transitory computer readable storage media to manage content items for end users that, when read and executed by a processing system, direct the processing system to at least:
determine first content items to be presented to an end user;
determine a first sequence for the first content items;
monitor user interactions with one or more secondary services;
determine content of interest for the end user based on the user interactions;
determine second content items to be presented to the end user based on the content of interest; and
determine a second sequence for the second content items based on the content of interest.

20. The apparatus of claim 19, wherein the program instructions further direct the processing system:
generating a first display comprising the first content items in the first sequence; and
generating a second display comprising the second content items in the second sequence.
